(19) United States
(12) Patent Application Publication
(10) Pub. No.: US 2013/0133988 A1
(43) Pub. Date: May 30, 2013

(54) METHOD FOR OPERATING A BRAKE SYSTEM OF A VEHICLE

(71) Applicant: Ford Global Technologies, LLC, Dearborn, MI (US)

(72) Inventors: Thomas Svensson, Leichlingen (DE); Ian Moore, Pulheim (DE); Rudolf Daniels, Wermelskirchen (DE)

(73) Assignee: FORD GLOBAL TECHNOLOGIES, LLC, Dearborn, MI (US)

(21) Appl. No.: 13/681,691

(22) Filed: Nov. 20, 2012

(30) Foreign Application Priority Data
Nov. 25, 2011 (DE) 102011087118.7

(51) Int. Cl. B60T 8/1755; B60T 1/06

(52) U.S. Cl. CPC B60T 8/1755; B60T 1/065
USPC 188/72.1; 701/70; 188/152

(57) ABSTRACT

A method for operating a brake system of a vehicle is described. The vehicle includes a service brake having a brake master cylinder and a plurality of wheels each having a respective brake device. Upon attainment of a given measurement value, in particular in the context of a stability control procedure, a brake pressure is built up by means of the brake master cylinder at the brake devices of all wheels.

### FIELD OF THE INVENTION

The present invention generally relates to a method for operating a brake system of a vehicle, in particular a motor vehicle. In addition, the invention relates to a vehicle and a brake system such as a disk brake system for a vehicle, in particular a motor vehicle with stability control.

### BACKGROUND OF THE INVENTION

Numerous vehicles, for example motor vehicles and also bicycles, include disk brakes. A disk brake consists typically of a pair of brake linings or friction elements mounted movably on a brake caliper housing. The wheel to be braked typically includes a brake disk which rotates with the wheel and can be pressed against the brake linings or friction elements in order to brake the wheel. In this case the brake linings or friction elements may be moved towards the brake disk hydraulically or mechanically. In the case of hydraulic disk brakes, so-called rollback seals are widely used. These cause the brake piston which is moved hydraulically during a braking process to be returned to its released starting position upon completion of the braking process.

It is desirable to provide a method for operating a brake system of a vehicle which increases the reaction speed and the effectiveness of the braking process, especially in conjunction with a stability control system. It is also desirable to provide an improved brake system for a vehicle. It is further desirable to provide an advantageous motor vehicle.

### SUMMARY OF THE INVENTION

According to one aspect of the present invention, a method is provided for operating a brake system of a vehicle including a service brake having a brake master cylinder and a plurality of wheels each having a respective brake device. The method includes the step of building up a brake pressure via the brake master cylinder at the brake devices of the plurality of wheels upon attainment of a given measurement value.

According to another aspect of the present invention, a brake system for a vehicle is provided. The brake system includes a service brake having a brake master cylinder and a plurality of wheels and a respective brake device associated with each of the plurality of wheels. The system also includes a device for controlling the build-up of brake pressure at the brake devices of the plurality of wheels via the brake master cylinder upon attainment of a given measurement value.

According to a further aspect of the present invention, a vehicle is provided. The vehicle includes a plurality of wheels and a brake system. The brake system includes a service brake having a brake master cylinder, a brake device associated with each of the plurality of wheels, and a device for controlling the build-up of brake pressure at the brake devices of the plurality of wheels via the brake master cylinder upon attainment of a given measurement value.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a schematic diagram illustrating a brake system for a vehicle, according to one embodiment;

FIG. 2 is a cross-sectional view of a brake device of the brake system and associated with a particular wheel in the released state; and

FIG. 3 is a cross-sectional view of the brake device associated with a wheel in the preloaded state.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

In the context of the present invention a rollback seal is understood to mean any seal which can assist the retraction of a piston when the pressure of a hydraulic or other fluid which moves the brake piston has decreased. Rollback seals are usually arranged between the respective brake piston and the associated brake caliper housing. In addition, the rollback seal has the effect that the respective brake piston is preloaded from the braking position to the released position. That is to say that the rollback seal is, for example, deformed elastically when the brake piston is moved from the released position to the braking position, and generates an elastic restoring force in order to move the brake piston back to the released position upon completion of the braking process.

Stability control systems (abbreviated as ESP or ESC—Electronic Stability Program, Electrical Stability Control) are used in motor vehicles. The stability control device has the effect that, by specified braking of individual wheels, breakaway of the vehicle is prevented, or breakaway of the vehicle is counteracted. For example, the stability control system is activated when a given predefined yaw angle or a given predefined yaw rate has been reached or exceeded. The stability control system then builds up a brake pressure at a single wheel or at a plurality of wheels in order to stabilize the vehicle.

Stability control systems are also known which build up a low hydraulic pressure at the wheel brakes before the particular predetermined yaw index or the particular predetermined yaw rate designated for the final intervention of the stability control system has been reached.

However, the effectiveness of the stability control system in the particular operating situation of the vehicle depends on the particular response behavior at the time of the wheel brake addressed, which behavior may be determined, for example, by external conditions and the operating state of the vehicle.

The method for operating a brake system of a vehicle relates to a vehicle which includes a service brake with a brake master cylinder and a number of wheels each having a brake device. In the context of the method, a brake pressure is increased to build up at the brake devices of all of a plurality of wheels via the brake master cylinder upon attainment of a given measurement value. In this way, in the event of imminent braking, the actual braking process can be effectively prepared to such an extent that the reaction time or response time of the brake system when the actual braking process is initiated is considerably reduced. At the same time the effectiveness of the braking process is increased.

The given measurement value may be, for example, a physical measurement value such as, in particular, a given yaw rate of the vehicle, or an operating state value of the vehicle such as, in particular, a given vehicle speed. In the context of the method, the attainment of the given measurement value means both attainment from above that is, undershooting of the respective measurement value and attainment from below, that is, overshooting the respective measurement value.

The vehicle may be a wheeled motor vehicle. The respective brake devices may be, in particular, disk brakes according to one embodiment. The brake devices may in principle include brake pistons. In this case the brake pressure can be built up by supplying brake fluid from the brake master cylinder to the brake pistons of all of the plurality of wheels. In this way a stability control device which may be present, in particular a brake fluid pump for the stability control system, can be relieved of load. Because the respective brake pistons, and therefore the brake pads connected to the brake pistons, are already preloaded by means of the brake pressure already built up with the aid of the brake master cylinder before the final triggering of the stability control system, the stability control system is fully available for its actual function, namely stabilizing the vehicle.

Upon reaching or exceeding a given yaw rate of the vehicle, a brake pressure may be built up by means of the brake master cylinder at the brake devices of all of the plurality of wheels. In this way the effectiveness of a stability control system is improved in that all the rollback seals which may, for example, be present are already closed and the brake linings are already heated to a uniform temperature before the stability control system is triggered. Because, as a rule, only individual wheels are braked during a stability control operation, the stabilization time normally depends on the reaction time and the friction conditions at the individual wheel brakes at the time. With the aid of the present method, firstly, the reaction time for the individual wheel brakes is reduced; secondly the friction conditions at the individual brakes are made uniform and improved. In this way the time required until the vehicle is stabilized in the event of triggering of a stability control system is reduced.

Furthermore, upon exceeding of a given vehicle speed, for example upon exceeding a vehicle speed of 40 km/h, 50 km/h, 70 km/h, 90 km/h or 110 km/h, a brake pressure can be built up by means of the brake cylinder at the brake devices of all wheels. In this way, upon exceeding of given vehicle speeds, a possible braking process is effectively prepared and both the reaction time and the effectiveness of the actual braking process are enhanced or improved.

In addition, if a given outside temperature is not reached, for example if an outside temperature of −10° C. or −20° C. is not reached, a brake pressure can be built up by means of the brake master cylinder at the brake devices of all wheels. The friction elements or brake linings are thereby heated. In this way, because the frictional behavior, and therefore the braking behavior, of the friction elements or the brake linings is generally poorer at low temperatures than with heated friction elements, high effectiveness of the brake system, especially at low temperatures, is ensured.

A further embodiment for ensuring high effectiveness of the brake system includes building up the brake pressure via the brake master cylinder at certain time intervals according to one embodiment. In this case the brake pressure may be built up, for example automatically, at certain time intervals.

A further embodiment of the brake system includes building up the brake pressure in dependence on certain operating states of the service brake, for example in dependence on the frequency and type of operation of the foot brake of a motor vehicle by the driver of the motor vehicle. In this way, an appropriate effectiveness of the brake system can be ensured in dependence on the particular operating situation.

The individual brake devices may include rollback seals according to one embodiment. Advantageously, the brake pressure may be built up at least until the rollback seals are closed. A stability control system can thereby be considerably relieved of load by means of the brake master cylinder.

As already mentioned, the brake devices may include friction elements or brake linings. These friction element or brake linings may be heated upon reaching a given measurement value by building up the brake pressure. The coefficient of friction, and therefore the effectiveness of the braking process, can thereby be increased.

The brake master cylinder may be controlled electronically according to one embodiment. According to another embodiment, the brake master cylinder may be controlled mechanically. As already mentioned, the method can be used very advantageously for controlling vehicle stability. The method of building up brake pressure may be executed before actually executing the method for controlling vehicle stability; that is to say that a brake pressure can be built up at the brake devices of all wheels by means of the brake master cylinder before the stability control system is triggered.

The brake system for a vehicle relates to a vehicle which includes a service brake having a brake master cylinder and a number of wheels each having a brake device. In addition, the brake system includes a device for controlling the build-up of brake pressure at the brake devices of all wheels by means of the brake master cylinder upon attainment of a given measurement value. With the aid of the brake system, the aforedescribed method can be carried out. The brake system may advantageously include a device for controlling vehicle stability. Furthermore, the brake devices may be disk brakes.

In addition, the brake system may include a device for measuring and/or detecting the yaw rate or the yaw index of the vehicle. In addition, the brake system according to various embodiments may include a device for measuring and/or detecting the outside temperature and/or the speed of the vehicle.

The vehicle, which may be, for example, a motor vehicle, includes a brake system described previously. Both the brake system and the vehicle have the same advantages as the method already described.

With the aid of the brake system, the response time of a brake in the event of a concrete braking situation can be reduced. Furthermore, the effectiveness, in particular the coefficient of friction, can be increased. This applies, in particular, in the case of low outside temperatures or of critical driving situations in which uniform, effective and rapid braking behavior of all wheel brakes is required. Furthermore, the effectiveness and reaction speed of a stability control system can be increased by the brake system.

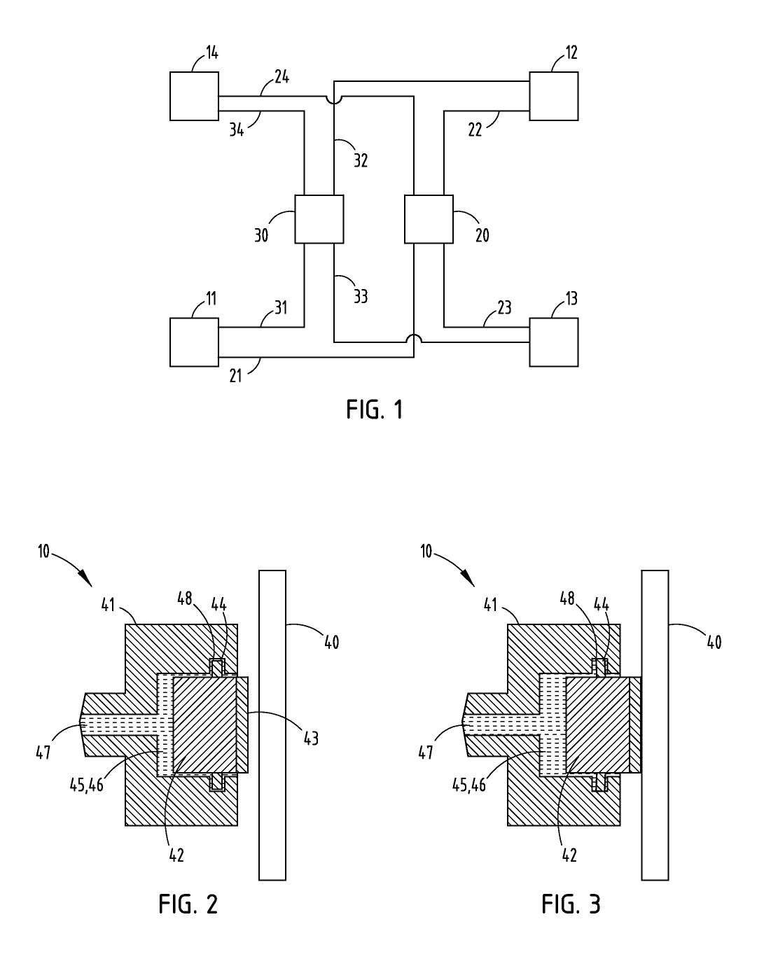

An exemplary embodiment of the brake system is explained in more detail below with reference to FIGS. 1 to 3. FIG. 1 shows schematically a brake system according to one embodiment for a motor vehicle. The brake system includes a brake master cylinder 30, a stability control device 20 and four brake devices 11, 12, 13, 14. The four brake devices 11, 12, 13, 14 are each associated with a respective wheel of the motor vehicle and serve to brake the respective wheel. The brake master cylinder 30 is connected to the four brake devices 11, 12, 13, 14 via respective brake fluid lines 31, 32, 33, 34.

Brake fluid is directed from the brake master cylinder 30 to the first brake device 11 via a first brake fluid line 31, from the brake master cylinder 30 to the second brake device 12 via a second brake fluid line 32, from the brake master cylinder 30 to the third brake device 13 via a third brake fluid line 33 and from the brake master cylinder 30 to the fourth brake device 14 via a fourth brake fluid line 34.

The stability control device 20 serves to counteract breakaway or swerving of the vehicle, for example of the motor vehicle, by specified braking of the individual wheels. In this case brake fluid is directed in a specified manner by means of pumps to the respective wheel to be braked via corresponding brake fluid lines 21, 22, 23, 24. In FIG. 1, the stability control device 20 communicates via a first brake fluid line 21 with the first brake device 11, via a second brake fluid line 22 with the brake device 12 of the second wheel, via a third brake fluid line 23 with the brake device 13 of the third wheel and via a brake fluid line 24 with the brake device 14 of the fourth wheel.

FIGS. 2 and 3 show in an exemplary manner a brake device 10 associated with a particular wheel. FIG. 2 shows the brake device 10 in the released state and FIG. 3 shows the brake device 10 in the preloaded state. The brake device 10 shown in FIGS. 2 and 3 may be, for example, one of the brake devices 11, 12, 13, 14 shown in FIG. 1.

The brake device 10 includes a brake disk 40 which is connected to the respective wheel to be braked in such a way that braking of the rotating brake disk 40 at the same time causes braking of the respective wheel. The brake device 10 further includes a brake piston 42. The brake piston 42 has oriented towards the brake disk 40 a surface on which a friction element or brake lining 43 is arranged. The friction element or brake lining 43 has a high coefficient of friction, for example a high coefficient of static friction and a high coefficient of sliding friction. In the event of mechanical contact between the friction element 43 and the surface of the brake disk 40, friction arising between the surface of the brake disk 40 and the friction element 43 causes braking of the brake disk 40.

The brake piston 42 is arranged in the interior chamber 46 of a housing 41. The housing 41 includes grooves 48 which are arranged in the interior chamber 46 of the housing 41. Rollback seals 44 are arranged in the grooves 48. The rollback seals 44 are arranged between the brake piston 42 and the housing 41 and seal these elements with respect to one another.

Brake fluid 45, which is enclosed by the housing 41, the rollback seals 44 and the brake cylinder 42, is contained in the interior chamber 46 of the housing 41. The housing 41 further includes a brake fluid line 47 via which the pressure of the brake fluid 45 in the interior chamber of the housing 41 can be increased in the event of braking. The brake piston 42 is arranged in the housing 41 in such a way that it can be moved or pressed in the direction of the brake disk 40, that is, out of the interior chamber 46, by an increase in the pressure of the brake fluid 45.

FIG. 2 shows the brake device 10 in the released state. In FIG. 3 the pressure of the brake fluid 45 has been increased. As a result, the brake piston 42 has been pressed towards the brake disk 40 and applied thereto. In FIG. 3 the rollback seals 44 are closed and preloaded. The rollback seals 44 have the effect that the brake piston 42 is preloaded from the braking position shown in FIG. 3 towards the released position shown in FIG. 2. In this case the rollback seals 44 are deformed elastically when the brake piston 42 is moved from the released position (FIG. 2) to the braking position (FIG. 3). An elastic restoring force with the aid of which the brake piston 42 is moved back to the released position is thereby generated when the pressure of the brake fluid 45 decreases upon completion of the braking process, and the brake fluid 45 is withdrawn from the interior chamber 46 again.

In the context of the method, upon attainment of a given measurement value, for example when a given outside temperature is undershot and/or a given minimum speed is exceeded and/or a given yaw rate is exceeded, brake fluid is directed from the brake master cylinder 30 to all the individual wheels, four wheels 11, 12, 13, 14 in the present exemplary example. In this way the brake devices 11, 12, 13, 14 are preloaded, as shown in FIG. 3. The reaction time of the brake devices 10, 11, 12, 13 is thereby reduced upon initiation of the actual braking process, for example as a result of the intervention of the stability control device 20. Furthermore, through cleaning of the brake disk 40 and pre-heating of the friction elements 43 already achieved in the period preceding the actual braking process, the efficiency of the respective brake device 10, 11, 12, 13, 14 is increased upon initiation of the actual braking process.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A method for operating a brake system of a vehicle comprising a service brake having a brake master cylinder and a plurality of wheels each having a respective brake device, said method comprising the step of:
building up a brake pressure via the brake master cylinder at the brake devices of the plurality of wheels upon attainment of a given measurement value.

2. The method as claimed in claim 1, wherein the brake devices comprise brake pistons and the brake pressure is built up by supplying brake fluid from the brake master cylinder to the brake pistons of the plurality of wheels.

3. The method as claimed in claim 1 further comprising the step of sensing yaw rate of the vehicle and comparing the yaw rate to the given measurement value, wherein the brake pressure is built up upon the yaw rate reaching the given measurement value.

4. The method as claimed in claim 1 further comprising the step of sensing outside temperature of the vehicle and comparing the outside temperature to the given measurement value, wherein the brake pressure is built up upon the outside temperature reaching the given measurement value.

5. The method as claimed in claim 4, wherein if an outside temperature falls below −10° C., a brake pressure is built up by means of the brake master cylinder at the brake devices of the plurality of wheels.

6. The method as claimed in claim 1 further comprising the step of sensing vehicle speed of the vehicle and comparing the vehicle speed to the given measurement value, wherein the brake pressure is built up upon the vehicle speed reaching the given measurement value.

7. The method as claimed in claim 6, wherein if a vehicle speed of 40 km/h is exceeded, a brake pressure is built up by means of the brake master cylinder at the brake devices of the plurality of wheels.

8. The method as claimed in claim 1, wherein upon attainment of at least one of a given yaw rate of the vehicle and upon undershooting of a given outside temperature and upon exceeding of a given vehicle speed, a brake pressure is built up by means of the brake master cylinder at the brake devices of the plurality of wheels.

9. The method as claimed in claim 8, wherein if at least one of an outside temperature falls below −20° C. and a vehicle speed of 50 km/h is exceeded, a brake pressure is built up by the brake master cylinder at the brake devices of the plurality of wheels.

10. The method as claimed in claim 1, wherein the brake pressure is built up at certain time intervals and in certain operating states of the service brake.

11. The method as claimed in claim 1, wherein the brake devices include rollback seals and the brake pressure is built up at least until the rollback seals are closed.

12. The method as claimed in claim 1, wherein the brake devices include friction elements and the friction elements are heated by the build-up of the brake pressure upon attainment of the given measurement value.

13. The method as claimed in claim 1, wherein the brake master cylinder is controlled electronically.

14. The method as claimed in claim 1, wherein the brake master cylinder is controlled mechanically.

15. The method as claimed in claim 1, wherein the method is used in the context of a stability control procedure.

16. A brake system for a vehicle comprising:
a service brake having a brake master cylinder and a plurality of wheels;
a respective brake device associated with each of the plurality of wheels; and
a device for controlling the build-up of brake pressure at the brake devices of the plurality of wheels via the brake master cylinder upon attainment of a given measurement value.

17. The brake system as claimed in claim 16, wherein the brake system includes a stability control device.

18. The brake system as claimed in claim 16, wherein the brake devices are disk brakes.

19. A vehicle comprising:
a plurality of wheels; and
a brake system comprising:
a service brake comprising a brake master cylinder;
a brake device associated with each of the plurality of wheels; and
a device for controlling the build-up of brake pressure at the brake devices of the plurality of wheels via the brake master cylinder upon attainment of a given measurement value.
